(19) United States
(12) Patent Application Publication
(10) Pub. No.: US 2025/0335893 A1
(43) Pub. Date: Oct. 30, 2025

(54) COMPUTER-BASED SYSTEMS FOR ALERTING A USER VIA AT LEAST ONE MAGNETIC COMPONENT THAT AN ACTIVITY INSTRUMENT IS READY FOR USE OR BEING REMOVED, AND METHODS OF USE THEREOF

(71) Applicant: Capital One Services, LLC, McLean, VA (US)

(72) Inventors: Lee Adcock, Midlothian, VA (US); Stephen McCrowey, McLean, VA (US); Carolyn Aquino, McLean, VA (US)

(21) Appl. No.: 18/646,577

(22) Filed: Apr. 25, 2024

(51) Int. Cl. G06Q 20/20; G06K 7/08

(52) U.S. Cl. CPC G06Q 20/204; G06K 7/087

(57) ABSTRACT

A method of an activity computing device having a first magnetic component switching between a first and a second mode includes receiving a first indication of an activity, and instructing the first magnetic component to generate: when in the first mode: a first magnetic field having a first polarity that is configured to interact with a second magnetic field generated by a second magnetic component of the activity instrument, wherein the second magnetic field has a second polarity that is the same as the first polarity so that the activity computing device generates a repulsive force, and when in the second mode: a third magnetic field having a third polarity that is configured to interact with the second magnetic field generated by the second magnetic component, wherein the third polarity is opposite to the second polarity so that the activity computing device generates a pulling magnetic force.

### TECHNICAL FIELD

The present disclosure generally relates to computer-based systems and methods involving improved activity instruments and activity computing devices. More specifically, the present disclosure relates to computer-based systems and methods including improved activity instruments having magnetic components for interaction with activity computing devices.

### BACKGROUND

Conventional point-of-sale systems interact with physical activity instruments so as to complete an activity involving products or services. Activity computing devices often include a physical activity instrument reading component that interacts with the physical activity instrument to perform the activity. The physical activity instrument is often swiped through, inserted into or tapped onto the physical activity instrument reading component to transfer information from the physical activity instrument to the physical activity instrument reading component to complete the activity.

### SUMMARY

In some embodiments, the present disclosure provides an exemplary technically improved computer-based system/method/apparatus that includes at least the following components/steps of receiving, by at least one processor of an activity computing device, a first indication that a user has initiated an activity; where the activity computing device is configured to receive an activity instrument to perform the activity; where the activity computing device includes at least one first magnetic component in a first mode; where, in the first mode, the at least one first magnetic component generates a first magnetic field having a first polarity that is configured to interact with a second magnetic field generated by at least one second magnetic component of the activity instrument; where the second magnetic field has a second polarity that is the same as the first polarity so that the activity computing device generates a repulsive force when the activity instrument is in proximal engagement with the activity computing device indicating to the user that the activity computing device is not prepared to receive the activity instrument; receiving, by the at least one processor of the activity computing device, a second indication that the activity is ready for performance using the activity instrument; generating, by the at least one processor of the activity computing device, a request to activate the activity instrument for performance of the activity; transmitting, by the at least one processor of the activity computing device, to a server of an entity associated with the activity instrument, the request to activate the activity instrument for performance of the activity; receiving, by the at least one processor of the activity computing device, a third indication that the activity instrument: has been activated or has not been activated; instructing, by the at least one processor of the activity computing device, when the activity instrument has been activated, the at least one first magnetic component to switch from the first mode to a second mode; where, in the second mode, the at least one first magnetic component generates a third magnetic field having a third polarity that is configured to interact with the second magnetic field generated by the at least one second magnetic component of the activity instrument; where the third polarity is opposite to the second polarity so that the activity computing device generates a pulling magnetic force when the activity instrument is in proximal engagement with the activity computing device, indicating to the user that the activity computing device is prepared to receive the activity instrument so as to facilitate the performance of the activity.

In some embodiments, the present disclosure provides an exemplary technically improved computer-based system/method/apparatus that includes at least the following components/steps of receiving, by at least one processor of an activity computing device, a first indication that a user has initiated an activity; where the activity computing device is configured to receive an activity instrument to perform the activity; where the activity computing device includes: at least one first magnetic component configured to generate a first magnetic field; a sensor configured to determine a first polarity of a second magnetic field generated by at least one second magnetic component of the activity instrument; and an activity instrument reading component; determining, by the at least one processor of the activity computing device, when the activity instrument is brought into proximal engagement with the activity instrument reading component, a first polarity of the second magnetic field generated by the at least one second magnetic component of the activity instrument; performing, by the at least one processor of the activity computing device, one of: instructing, by the at least one processor of the activity computing device, the at least one first magnetic component to generate the first magnetic field having a second polarity that is the same as the first polarity of the second magnetic field if the activity instrument reading component is not prepared to receive the activity instrument; where the second polarity of the first magnetic field interacts with the first polarity of the second magnetic field to generate a repulsive force between the activity computing device and the activity instrument; instructing, by the at least one processor of the activity computing device, the at least one first magnetic component to generate the first magnetic field having a third polarity that is opposite the first polarity of the second magnetic field if the activity instrument reading component is prepared to receive the activity instrument; where the third polarity of the first magnetic field interacts with the first polarity of the second magnetic field to generate a pulling force between the activity computing device and the activity instrument so as to facilitate the performance of the activity.

In some embodiments, the present disclosure provides an exemplary technically improved computer-based system/method/apparatus that includes at least the following components/steps of an activity computing device; a provider server configured to execute software instructions that cause the activity computing device to at least: receive an indication that a user has initiated an activity; where the activity computing device is configured to receive an activity instrument to complete the activity; where the activity computing device includes a first at least one magnetic component in a default mode; where the first at least one magnetic component includes at least one electromagnet; where, in the default mode, the first at least one electromagnet generates a first magnetic field having a first polarity that is configured to interact with a second magnetic field generated by a second at least one magnetic component of the activity instrument; where the second magnetic field has a second polarity that is the same as the first polarity so that the activity computing device generates a repulsive force on the activity instrument when the activity instrument is in proximal engagement with the activity computing device, indicating to the user that the activity computing device is not prepared to receive the activity instrument; receive an indication that the activity is ready for performance using the activity instrument; generate a request to activate the activity instrument for performance of the activity; transmit to a server of an entity associated with the activity instrument, the request to activate the activity instrument for performance of the activity; receive an indication that the activity instrument is one of: activated; or not activated; instruct, when the activity instrument is activated, the first at least one magnetic component to switch from the default mode to an activity performance mode; where, in the activity performance mode, the first at least one electromagnetic generates a third magnetic field having a third polarity that is configured to interact with the second magnetic field generated by the second at least one magnetic component of the activity instrument; where the third polarity is opposite the second polarity so that the activity computing device generates a pulling force on the activity instrument when the activity instrument is in proximal engagement with the activity computing device, indicating to the user that the computing device is prepared to receive the activity instrument; receive the activity instrument to perform the activity.

### BRIEF DESCRIPTION OF THE DRAWINGS

Various embodiments of the present disclosure can be further explained with reference to the attached drawings, where like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram illustrating an exemplary computer-based system for alerting a user, via at least one magnetic component, that a physical activity instrument is ready for use, according to one or more embodiments of the present disclosure.

FIG. 2 is a block diagram of an exemplary physical activity instrument, according to one or more embodiments of the present disclosure.

FIG. 3 is a process flow diagram illustrating an example of a computer-based process for alerting a user, via at least one magnetic component, that a physical activity instrument is ready for use, according to one or more embodiments of the present disclosure.

FIG. 4 is a process flow diagram illustrating an example of a computer-based process for alerting a user, via at least one magnetic component, that a physical activity instrument is ready for use, according to one or more embodiments of the present disclosure.

FIG. 5 is a process flow diagram illustrating an example of a computer-based process for alerting a user, via at least one magnetic component, that a physical activity instrument is ready for use, according to one or more embodiments of the present disclosure.

FIG. 6 is a block diagram illustrating an exemplary computer-based system and platform, according to one or more embodiments of the present disclosure.

FIG. 7 is a block diagram illustrating another exemplary computer-based system and platform, according to one or more embodiments of the present disclosure.

FIG. 8 is a schematic illustration of an exemplary implementation of a cloud computing/architecture(s) in which the exemplary inventive computer-based system and platform of the present disclosure may be specifically configured to operate, according to one or more embodiments of the present disclosure.

FIG. 9 is another schematic illustration of an exemplary implementation of a cloud computing/architecture(s) in which the exemplary inventive computer-based system and platform of the present disclosure may be specifically configured to operate, according to one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

As used herein, the term “customer”, “client” or “user” shall have a meaning of at least one customer or at least one user respectively.

As used herein, the term “mobile computing device”, “user device” or the like, may refer to any portable electronic device that may include relevant software and hardware. For example, a “mobile computing device” can include, but is not limited to, any electronic computing device that is able to among other things receive and process alerts from a customer or a financial entity including, but not limited to, a mobile phone, smart phone, or any other reasonable mobile electronic device that may or may not be enabled with a software application (App) from the user's financial entity.

In some embodiments, a “mobile computing device” or “user device” may include computing devices that typically connect using a wireless communications medium such as cell phones, smart phones, tablets, laptops, computers, pagers, radio frequency (RF) devices, infrared (IR) devices, CBs, integrated devices combining one or more of the preceding devices, or virtually any mobile computing device that may use an application, software or functionality to receive and process alerts, credit offers, credit requests, and credit terms from a customer or financial institution.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, the term “activity instrument” or “physical activity instrument” may refer to any electronic instrument with at least one embedded microprocessor. In some embodiments, the activity instrument may be a transaction card such as a credit or debit card. In some embodiments, the activity instrument may be any card or similar instrument configured to perform an activity such as, for example, a security card, a fob, etc.

In some embodiments, the term “transaction card” may refer to an electronic card with at least one embedded microprocessor. In some embodiments, the transaction card may be dimensioned and/or be utilized such as, but not limited to, a conventional credit or debit card issued to account holders by banks and other financial institutions. In some embodiments, the transaction card may be dimensioned and/or be utilized such as, but not limited to, personal identification cards, health entitlement cards, store loyalty cards, stored value cards (electronic purses), information storage cards, and the like. In some embodiments, the transaction card may be dimensioned, but not limited to, in accordance with international standard ISO/IEC 7810, ID-1 format, which specifies dimensions of 85.60 mm (85.60×10−3 m) long by 53.98 mm (53.98×10−3 m) wide. In some embodiments, the transaction card may be dimensioned, but not limited to, in accordance with international standard ISO/IEC 7813 further specifies the thickness as 0.76 mm (0.76×10−3 m). For example, the transaction card may be made of a plastic material, metal or similar material, and may have convenient overall dimensions of 7.5 cm by 11 cm by 1 cm similar to a common wallet.

As explained in more detail, below, transaction cards, systems, and methods for alerting a user that a transaction card is activated for use with, e.g., a POS and/or other computing device, are disclosed. According to some embodiments, the transaction cards and other innovations herein may be implemented in connection with a financial service entity that provides, maintains, manages, or otherwise offers financial services. Here, for example, the financial service entity may be a bank, credit card issuer, or any other type of financial service entity that generates, provides, manages, and/or maintains financial service accounts that entail providing a transaction card for one or more customers, such as a transaction card for use at a POS device or with an online entity for an online purchase or transaction that involves or is associated with such financial service entity. Financial service accounts may include, for example, credit card accounts, bank accounts such as checking and/or savings accounts, reward or loyalty program accounts, debit account, and/or any other type of financial service account known to those skilled in the art.

Conventional point-of-sale systems interact with physical activity instruments so as to complete an activity involving products or services. Point-of-sale systems often include a physical activity instrument reading component that interacts with the physical activity instrument to perform the activity. The physical activity instrument interacts with the physical activity instrument reading component by being swiped through, inserted into or tapped onto the physical activity instrument reading component to transfer payment information from the physical activity instrument to the physical activity instrument reading component to complete the transaction. If a physical activity instrument is interacted with the physical activity instrument reading component too early, the user may be prompted to remove the physical activity instrument from the physical activity instrument reading component. In some instances, the transaction may even be cancelled. This is not a fluid experience for the user or the merchant.

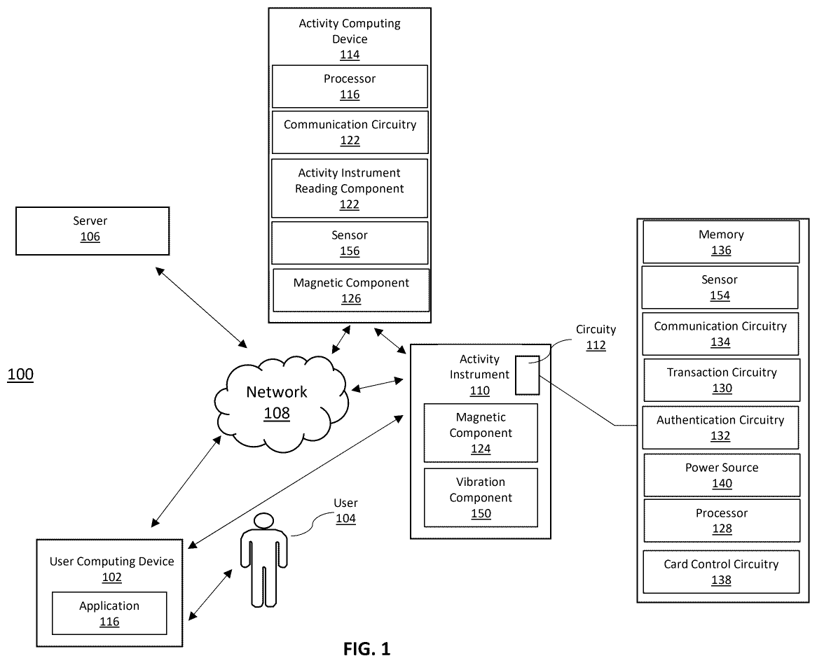

FIGS. 1 through 9 illustrate systems and methods for alerting a user, via at least one magnetic component, that a physical activity instrument (e.g., a transaction card) is ready for use with an activity computing device (e.g., a POS device) or other computing device to complete a transaction. In some embodiments, the transaction card is configured to react to a magnetic field created by a computing device such as, for example, a POS device. In some embodiments, the transaction card may be configured to vibrate or provide a magnetic pull when in the vicinity of the computing device. The following embodiments provide technical solutions and technical improvements that overcome technical problems, drawbacks and/or deficiencies in the technical fields involving fluid interactions between transaction cards and computing devices. As explained in more detail, below, the present disclosure provides technically advantageous computer architecture that improves transaction completion when interacting a transaction card with a computing device. Such interactions may help prevent premature insertion of the transaction card into the computing device, requiring the user to remove the transaction card and insert again at a later time. In some embodiments, the system and methods are technologically improved by incorporating magnetic components into the transaction card and the computing device. Based on such technical features, further technical benefits become available to users and operators of these systems and methods. Moreover, various practical applications of the disclosed technology are also described, which provide further practical benefits to users and operators that are also new and useful improvements in the art.

FIG. 1 is a block diagram illustration of an exemplary system 100 used to implement one or more embodiments of the present disclosure. The components and arrangements shown in FIG. 1 are not intended to limit the disclosed embodiments as the components used to implement the disclosed processes and features may vary. In accordance with disclosed implementations, the system 100 may include a server 106 in communication with a user computing device 102 associated with a user 104 via a network 108. In some embodiments, the system 100 also includes a transaction card 110 with circuitry 112 disposed therein and a point-of-sale or point-of-service device 114 which may also communicate with the server 106 and the user computing device 102 via the network 108.

Network 108 may be of any suitable type, including individual connections via the internet such as cellular or Wi-Fi networks. In some embodiments, network 108 may connect participating devices using direct connections such as radio-frequency identification (RFID), near-field communication (NFC), Bluetooth™, low-energy Bluetooth™ (BLE), Wi-Fi™, ZigBee™ ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

In some embodiments, server 106 may be associated with one or more entities that are stakeholders to the attempted transaction, such as the business or merchant, one or more financial services providers, such as an issuer of a credit card, debit card, or other transaction card associated with the attempted transaction.

In some embodiments, the server 106 may include one or more logically or physically distinct systems. As further described herein, the server 106 may perform operations (or methods, functions, processes, etc.) that may require access to one or more peripherals and/or modules.

As seen in FIG. 1, the server 106 may include a processor, RAM, ROM, network interface, input/output interfaces (e.g., keyboard, mouse, display, printer, etc.), and memory. In some embodiments, the processor may include one or more computer processing units (CPUs), graphical processing units (GPUs), and/or other processing units such as a processor adapted to perform computations associated with machine learning. In some embodiments, the processor may include any type of data processing capacity, such as a hardware logic circuit, for example, an application specific integrated circuit (ASIC) and a programmable logic, or such as a computing device, for example a microcomputer or microcontroller that includes a programmable microprocessor. In some embodiments, the I/O may include a variety of interface units and drives for reading, writing, displaying, and/or printing data or files. In some embodiments, the I/O may be coupled with a display such as display. In some embodiments, the memory may store software for configuring the server 106 into a special purpose computing device in order to perform one or more of the various functions discussed herein.

In some embodiments, the server 106 may operate in a standalone environment. In some embodiments, the server 106 may operate in a networked environment. As depicted in FIG. 1, the server 106 may be interconnected as network nodes via the network 108. In some embodiments, other networks may also or alternatively be used, including private intranets, corporate networks, LANs, wireless networks, personal networks, and the like. A local area network (LAN) may have one or more of any known network topologies and may use one or more of a variety of different protocols, such as Ethernet. In some embodiments, the server 106 may be connected to then network 108 via twisted pair wires, coaxial cable, fiber optics, radio waves or other communication media.

In some embodiments, the computing device 102 may be associated with the user 104. In some embodiments, the computing device 102 may generally include at least computer-readable non-transient medium, a processing component, an Input/Output (I/O) subsystem and wireless circuitry. In some embodiments, these components may be coupled by one or more communication buses or signal lines. In some embodiments, the computing device 102 may include a microprocessor, a memory, a contactless communication interface having a communication field and the display. The computing device 102 may also include means for receiving user input, such as a keypad, touch screen, voice command recognition, a stylus, and other input/output devices, and the display may be any type of display screen, including an LCD or LED display. In some embodiments, the computing device 102 may be, without limitations, a desktop computer, a laptop computer, a tablet, a mobile phone or portable device, or any other computing hardware. In some embodiments, the computing device 102 includes a user interface.

In some embodiments, the computing device 102 may be configured to execute software instructions for performing one or more operations consistent with the disclosed embodiments. In some embodiments, the computing device 102 may be a mobile device (e.g., tablet, smartphone, etc.), a desktop computer, a laptop, a server, a wearable device (eyeglasses, a watch, etc.), and/or dedicated hardware device. In some embodiments, the computing device 102 may include one or more processors configured to execute software instructions stored in memory, such as memory included in computing device 102. In some embodiments, the computing device 102 may include software that, when executed by a processor, performs known Internet-related communication and content display processes. For instance, in some embodiments, the computing device 102 may execute browser software that generates and displays interface screens including content on a display device included in, or connected to, the computing device 102. The disclosed embodiments are not limited to any particular configuration of the computing device 102. For instance, the computing device 102 may be a mobile device that stores and executes mobile applications that provide financial-service-related functions offered by a financial service provider, such as an application associated with one or more user profiles that a user holds with a financial service provider.

In some embodiments, the computing device 102 may have data connectivity to a network, such as the Internet, via a wireless communication network, a cellular network, a wide area network, a local area network, a wireless personal area network, a wide body area network, or the like, or any combination thereof. In some embodiments, through this connectivity, the computing device 102 may communicate with the server 106.

In some embodiments, the computing device 102 may include an application such as a financial application 116 (or application software) which may include program code (or a set of instructions) that performs various operations (or methods, functions, processes, etc.), as further described herein.

In some embodiments, the transaction card 110 may include various circuitry 112 including circuitry capable of communicating various card-related information from the transaction card 110, through the POS device 114 or other devices (e.g., a computing device with an online checkout process) or networks, to an online entity or computer system. Such card-related information may include activation and/or authentication instructions associated with a use of the one or both of the card and the mobile device for a transaction.

In some embodiments, the transaction card 110 may include at least one magnetic component 124. In some embodiments, the at least one magnetic component 124 may include an electromagnet. In some embodiments, the electromagnet may be a magnetic coil. In some embodiments, an electric current is inputted into the at least one magnetic component 124 via the various circuitry 112 to generate a magnetic field. In some embodiments, the transaction card 110 is configured to change the polarity of the magnetic field by changing the direction of the flow of the current through the at least one magnetic component 124. In some embodiments, the transaction card 110 is configured to change the polarity of the magnetic field based on a polarity of a magnetic field of the POS device 114, as will be described in further detail below. In some embodiments, the transaction card 110 may include at least one vibrating component 150 configured to vibrate the transaction card 110 when the POS device 114 is ready for insertion of the transaction card 110 therein.

In some embodiments, the card processor 128 may include at least one sensor 154 configured to sense a polarity of a magnetic field generated by at least one magnetic component 126 of the POS device 114. In some embodiments, the sensor 154 may be a magnetometer, a Hall Effect sensor, a magnetic field sensor, or any other sensor that is capable of measuring the polarity of the magnetic field generated by the at least one magnetic component 126 of the POS device 114.

In the embodiment shown in FIG. 1, an illustrative POS device 114 may include: at least one processor 118, i.e., one or more processing components and/or computer readable media, memory, communication circuitry 120, and at least one card reading component 122. The card reading component(s) 122 may be configured to read information from a transaction card 110, for example, the at least one card reading component may include one or more of a magnetic stripe reader, a chip reader, and/or a first near field communication (NFC) component. Communication circuitry 120 may include at least one mobile device transceiver component configured to communicate, e.g., in connection with a purchase transaction, with the mobile device 102 presented for payment, the mobile device transceiver component comprising a second NFC component.

In some embodiments, the POS device may be a mobile computing device such as any electronic computing device that is able to among other things receive and process alerts from a customer or a financial entity including, but not limited to, a mobile phone, smart phone, or any other reasonable mobile electronic device that may or may not be enabled with a software application (App) from the customer's financial entity.

In some embodiments, the POS device 114 may include at least one magnetic component 126. In some embodiments, the at least one magnetic component 126 may include an electromagnet. In some embodiments, the electromagnet may be a magnetic coil. In some embodiments, an electric current is inputted into the at least one magnetic component 124 via the various circuitry within the POS device 114 to generate a magnetic field. In some embodiments, the polarity of the magnetic field may be changed based on the flow of the current through the at least one magnetic component 124. In some embodiments, if the magnetic field formed by the POS device 114 is in the same direction as a magnetic field formed by the at least one magnetic component 124 of the transaction card 110, an attractive force may be generated between the transaction card 110 and the POS device 114. In some embodiments, the attractive force may create a pull on the transaction card 110, indicating to the user 104 that the POS device 114 is ready to receive the transaction card 110. In some embodiments, the attractive force may be strong enough to pull the transaction card 110 into or through the POS device 114. For example, in some embodiments, the attractive force may pull the transaction card 110 into the card reading component 122.

In some embodiments, if the magnetic field formed by the POS device 114 is in the opposite direction as a magnetic field formed by the at least one magnetic component 124 of the transaction card 110, a repulsive force may be generated between the transaction card 110 and the POS device 114. In some embodiments, the repulsive force may cause the transaction card 110 to be pushed away from the POS device 114, indicating that the POS device 114 is not ready to accept the transaction card 110. In some embodiments, the repulsive force may be strong enough to prevent the transaction card 110 from being able to interact with the POS device 114 at all. For example, the repulsive force may prevent the transaction card 110 from being inserted into the card reading component 122.

In some embodiments, the POS device 114 may include at least one sensor 156 configured to sense a polarity of a magnetic field generated by the at least one magnetic component 124 of the transaction card 110. In some embodiments, the sensor 156 may be a magnetometer, a Hall Effect sensor, a magnetic field sensor, or any other sensor that is capable of measuring the direction of the magnetic field generated by the at least one magnetic component 124.

With regard to the disclosed innovations, the at least one processor 118 may be configured to execute instructions associated with performing methods for receiving the information related to the authentication and/or activation of the transaction card 110 to perform the transaction attempted with the card 110 by the user 104. In some embodiments, the at least one processor 118 may be configured to execute instructions associated with, when the transaction is attempted by sliding the transaction card 110 through the card reading component 122, receiving information related to whether or not the transaction card 110 is authenticated and/or activated for activation of the at least one magnetic component 126. In some embodiments, the at least one processor 118 may be configured to execute instructions associated with, when the transaction is attempted to a contactless, NFC-enabled point of sale (POS) terminal, receiving the information related to whether or not the card is authenticated and/or active for activation of the at least one magnetic component 126.

In some embodiments, the disclosed transaction cards, systems, platforms, methods, and computer-readable media include or involve magnetic transaction card activation features that may include and/or involve various computing systems and/or components configured to perform various automated functionality set forth herein. Unlike existing solutions using conventional transaction cards, the present innovations may utilize an improved transaction card 110 that may, via manipulation of the at least one magnetic component 124 of the transaction card at or near the time of authorizing the transaction, provide improved features for activation of the transaction card 110. In these and other ways, implementations involving the present transaction card 110 and associated features, and functionality based on such magnetic component activation represent improvements over existing fraud prevention cards and techniques.

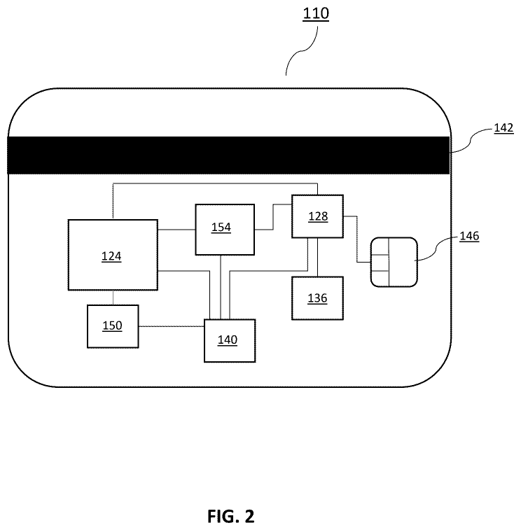

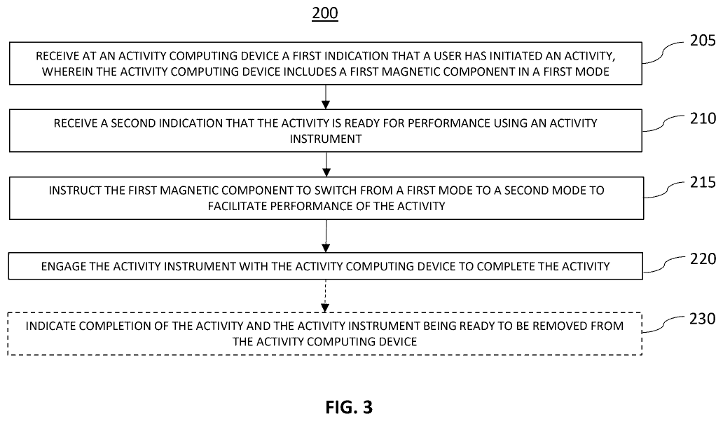

In some embodiments, transaction card 110 may be formed from plastic, metal, or any other suitable material. In some embodiments, transaction card 110 may include card circuitry 112 formed directly therein, and/or disposed therein by gluing, bonding or by any suitable adhesion method for affixing circuitry to the material of transaction card 110. In some embodiments, the card circuitry 112 may be configured to utilize any hardwired circuitry. In some embodiments, the card circuitry 112 may be implemented as one or more integrated circuit chips, and/or electronic devices, electrically interconnected and bonded to one or more circuit boards, for example. Further details and embodiments of exemplary transaction cards are shown and described in connection with FIGS. 2-3, below.

Referring to the block diagram of FIG. 1, in some embodiments, the card circuitry 112 may include at least one processor 128, transaction circuitry 130, authentication circuitry 132, communication circuitry 134, a memory 136, card control circuitry 138 and, optionally, a power source 140. In some embodiments, transaction circuitry 130 may include various electronic circuitry and/or components, including, in some embodiments, an embedded processor. In some embodiments, the memory 136 may store code, such as for the authentication circuitry 132, which when executed by processor 128 may cause processor 128 to implement verifying and transmitting data to the online and/or POS computers, and/or for other, related schemes herein (such as pairing with the user computing device 102) to perform magnetic card activation. As set forth in more detail, below, such features provide means to verify whether or not the transaction card 110 is activated or authenticated, e.g., to approve the use of the transaction card 110 when the user attempts to use the transaction card to perform a transaction at a POS device 114 or other computing device.

In some embodiments, the transaction circuitry 130 may be configured to conduct purchase transactions with the transaction card 110. For example, such purchase transactions may involve one or more of: i) a wireless computing device that is in a wireless communication with the transaction card; ii) an entity associated with each respective transaction; and/or iii) a server associated with a financial entity and in wireless communication with the transaction card. In some embodiments, the transaction circuitry 130 may include the one or more components that are configured to conduct transactions involving a point of sale (POS) device or other computing device. In some embodiments, the transaction circuitry 130 may further include one or more of: an EuroPay-MasterCard-Visa (EMV) chip, an EMV processor, wireless, near field communication (NFC), and/or Bluetooth communication chips/circuitry, or other financial transaction circuitry.

In some embodiments, the card control circuitry 138 may be configured to be operationally coupled to at least one of: the transaction circuitry 130, the communication circuitry 134. In some embodiments, the card control circuitry 138 is coupled to the at least one magnetic component 124. In some embodiments, the card control circuitry 138 may be configured to control the at least one magnetic component 124, the transaction circuitry 130 or the communication circuitry 134 based on an activation of the transaction card 110 via, for example, the server 106. In some embodiments, the card control circuitry 138 may be configured to control the at least one magnetic component 124, the transaction circuitry 130 or the communication circuitry 134 based on an authentication of the transaction card 110 via, for example, the server 106. In some embodiments, this authentication of the transaction card 110 may be based on an interaction/authorization performed by the user computing device 102. In some embodiments, the card control circuitry 138 may be configured to turn on or off the magnetic field of the at least one magnetic component 124. In some embodiments, the card control circuitry 138 may be configured to change the polarity of the at least one magnetic component 124. In some embodiments, the card control circuitry 138 may be further configured to turn on or off the Bluetooth circuitry such that the card 110 is not detectable by nearby Bluetooth devices.

In some embodiments, the communication circuitry 134 may include at least one of: near field communication (NFC) circuit or a Bluetooth communication circuit.

In some embodiments, the power source 140 may be used to power the card circuitry 112. In some embodiments, the power source 140 may include, for example, a battery, a solar cell, and/or any suitable energy harvesting device, capable of generating enough power for powering the card circuitry 112. In some embodiments, the transaction card 110 may be powered upon swiping or inserted the card into a slot in the POS device 114 such that the power source may be POS device 114 itself or any other device into which the transaction card is swiped or inserted. In some embodiments, the transaction card 110 may also be powered by movement, or by induction, or by other near-field electromagnetic energy derived from nearby sources, such as the user computing device 102, the POS device 114, or other known sources.

In some embodiments, the user computing device 102, such as a smart phone or other portable or wearable electronic device, may include mobile device circuitry. In some embodiments, mobile device circuitry may include a mobile device processor, a memory, such as RAM, communication circuitry and interface, and any input and/or output device, such as a touchscreen display. In some embodiments, RAM may store code that, when executed by processor, may cause the processor to implement aspects of one or more fraud detections schemes herein, including those involving pairing with transaction card 110 to authenticate the transaction card 110—i.e., verify if the user 104 is an authorized user of the transaction card 110. In some embodiments, the financial application 116 running on the user computing device 102 may include various modules that may transmit information to the POS device 114, relay information back to the financial institution (e.g., via the server 106), and/or communicate with other computing components.

Various embodiments associated with FIG. 1 and related disclosure herein solve a technical problem of ensuring that a transaction card is only activated for use when a transaction is ready for performing—e.g., when a POS device 114 is ready to receive the transaction card 110. In some embodiments, FIG. 1 and the related disclosure herein solve a technical problem of ensuring that a transaction card 110 is only activated for use when the transaction card 110 is authenticated by the server 106. In some embodiments, various features and functionality disclosed herein may be utilized in connection with fraud prevention and/or authentication processes that involve pairing of the transaction card 110 with the user computing device 102 when implementing multi-factor authentication (A/FA) schemes, for example to authorize the card for use by the user 104. In other embodiments, various information related to the successful pairing of the transaction card 110 and the user computing device 102 may be relayed back to server 106 so as to approve activation of the transaction card 110 for purchasing of goods or services.

In some embodiments, an initial authentication for pairing the transaction card 110 with the user computing device 102 may be implemented by the user 104 contacting the financial institution from the user computing device 102 to initially authorize the pairing of transaction card 110 with the user computing device 102 so as to receive pairing approval. In some embodiments, the pairing and/or unpairing processes between the transaction card 110 and the user computing device 102 may occur automatically and seamlessly such as without any action on the part of the user, particularly if the same user computing device 102 had been previously paired with the same transaction card 110 in the past. In some embodiments, proximity MFA may use biometrics (e.g., fingerprint, voice recognition, etc.) and/or a password entered by the user and/or a swiping of a screen of the user computing device 102 by a finger of the user 104 and/or the proximity of the transaction card 110 to the user computing device 102 or any user device, for example, to pair or unpair the transaction card 110 with the user 104.

In some embodiments, when the transaction card 110 includes a battery as power source 140, the user computing device 102 may be configured to pair with the transaction card 110 on the fly when the transaction card 110 is used during a transaction, so as to conserve power stored in the battery.

In some embodiments, if the transaction card 110 is determined to be in possession by an unauthorized individual via implementations herein, e.g. at/via the POS device 114, an entity associated with the transaction, such as a merchant deploying the POS device 114, may generate or receive an alarm or alert that the card user is potentially unauthorized (e.g., an alert on a display of the POS device 114) or that an additional authentication, such as second-factor authentication, should be performed to verify that the transaction is not fraudulent.

FIG. 2 shows a diagram of an exemplary transaction card 110, consistent with disclosed embodiments. In some embodiments, the transaction card 110 may be the approximate size and shape of a traditional credit card, debit card, or the like. In some embodiments, the transaction card 110 may have embedded electronics for performing various aspects of the disclosed innovations. As shown, in some embodiments, the transaction card 110 may include the at least one processor 128, the power source 140, the communication circuitry 134, the magnetic components 124, a magnetic stripe 142, a memory 144 and other circuitry 146 such as an electronic chip element and associated interconnects. In some embodiments, the power source 140 may include elements that generate power for the card upon interaction with the POS device 114, such as by connection via an electronic chip, and/or such circuitry may include a voltage supply such as a battery. In some embodiments, transaction card 110 may include more or fewer components than shown in FIG. 2.

In some embodiments, the memory 144 may include volatile or non-volatile, magnetic, semiconductor, or other type of storage elements and/or tangible (i.e., non-transitory) computer-readable medium that stores relevant instructions and data, such as information needed for or associated with conducting card transactions. In some embodiments, the instructions may include an applet comprising instructions for authenticating the transaction card 110 by requiring one or more of: i) an additional validation action; and/or ii) additional communication with the financial application 116 on the user computing device 102. Here, for example, the additional validation action may include a supplemental communication with the user 104 to validate the purchase transaction, such as via text, phone call, etc., supplemental action performed via the financial application 116 associated with the transaction card (such as requiring the user to log into their mobile app), and/or other communications to the user 104 that enable the user 104 to reply with an electronic communication to confirm such purchase. The additional communication with the financial application 116 on the user computing device 102 may include, for example, changing a setting within the financial application 116, responding to a prompt within the financial application 116 requesting validation of the purchase transaction, or simply requiring the user 104 to successfully log into the financial application 116.

In some embodiments, the operations may further include one or both of: (i) inform the POS device 114, at which the transaction is submitted, whether or not the transaction card 110 is authorized to perform the transaction; and/or (ii) instruct the POS device 114 to communicate by the Bluetooth communications with the financial application 116 on the user computing device 102 regarding performance of additional processing associated with the transaction attempt.

In some embodiments, the power source 140 may include a power storage device such as a battery or capacitor, a power receiver such as an inductive power coil or a wireless power receiver, a power generator such as a solar or kinetic power generator, or any combination thereof. In some embodiments, the power source 140 may include one or more other known devices capable of generating, receiving, and/or storing electrical energy.

In some embodiments, the transaction card 110 may, optionally, also include a display, which may include a screen, indicator light, or other appropriate device for displaying a status or message to user. In some embodiments, display may include a small LCD screen, e-ink screen, or OLED display or one or more LEDs. In some embodiments, display may provide notifications, prompts, and/or messages to user.

In some embodiments, transaction card 110 may include communication circuitry/devices 134 such as antennae and/or NFC (near-field communication) circuitry, for transmitting and/or receiving data from one or more external locations. In some embodiments, the communication circuitry 134 may include a short-range wireless transceiver, or a near-field communication (NFC) chip. In some embodiments, the communication circuitry 134 may be configured to communicate with the user computing device 102, a contactless card reader associated with the POS device 114, other systems, and/or other sensors configured to detect the presence of transaction card 110. In some embodiments, the communication circuitry/devices 134 may include Bluetooth circuitry for processing Bluetooth communications. In one example, the Bluetooth circuitry may include at least one Bluetooth antenna configured for Bluetooth low energy (BLE) communication. In another example, the communication circuitry/devices 134 may include RFID communication circuitry. In some embodiments, wireless access to user data on the transaction card 110 may be disabled until the transaction card 110 is activated.

In some embodiments, the transaction card 110 may include at least one magnetic stripe 142 or other magnetic communication medium that may share or read magnetically stored information. In some embodiments, the magnetic stripe 142 may be controlled by the processor 128. For example, the processor 128 may write, clear, and rewrite the magnetic stripe 142, to provide particular account information.

FIG. 3 is a process 200 for alerting a user that a POS device or other computing device is prepared to accept a transaction card, according to one or more embodiments of the present disclosure. The exemplary computer-mediated process 200 may be executed by software, hardware or a combination thereof. For example, process 200 may be performed by including one or more components described in the system 100 of FIG. 1 (e.g., user computing device 102, server 106, transaction card 110 and POS device 114). In some embodiments, some or all of the steps described below may be combined and/or divided into sub-steps as appropriate. It will be readily appreciated that other steps may be included in this method, and that not all steps are necessary in all situations.

At step 205, the user 104 initiates a transaction with the POS device 114 or other computing device. In some embodiments, initiating the transaction may include a merchant at the POS device 114 scanning merchandise the user 104 wishes to purchase. In some embodiments, initiating the transaction may include the merchant entering a service to be purchased by the user 104.

In some embodiments, during initiation of the transaction, the POS device 114 may be in a default sleep mode in which the at least one magnetic component 126 is disabled. In some embodiments, the POS device 114 may be in a default mode in which the at least one magnetic component 126 generates a magnetic field that has the same polarity as a known polarity of the transaction card 110 to be used such that if the user 104 brings the transaction card 110 into close proximity of or proximal engagement with the POS device 114, the user 104 feels a repulsive force on the transaction card 110.

In some embodiments, during initiation of the transaction, in addition to a repulsive force, the transaction card 110 may be configured such that the interaction of the electromagnetic field generated by the at least one magnetic component 126 of the POS device 114 interacts with the at least one vibrating component 150 to cause the transaction card 110 to vibrate when the transaction card 110 is brought into close proximity of the POS device 114.

In some embodiments, close proximity is a distance of 0.1 in to 3 in. In some embodiments, close proximity is a distance of 0.5 in to 3 in. In some embodiments, close proximity is a distance of 1 in to 3 in. In some embodiments, close proximity is a distance of 1.5 in to 3 in. In some embodiments, close proximity is a distance of 2 in to 3 in. In some embodiments, close proximity is a distance of 2.5 in to 3 in.

At step 210, the POS device may receive an indication from the merchant that the transaction is ready to be performed using the transaction card 110. In some embodiments, the POS device may request that the user 104 indicate the type of transaction card 110 that will be used (i.e., a transaction card with at least one magnetic component 124).

At step 215, the POS device 114 activates that at least one magnetic component 126 from the default mode to a transaction mode that indicates to the user 104 that the card reading component 122 is ready to receive the transaction card 110. In some embodiments, the at least one magnetic component 126 may be turned on by supplying an electric current thereto such that the at least one me magnetic component 126 generates an electromagnetic field. In some embodiments, the electromagnetic field has an opposing polarity of a known electromagnetic field of the transaction card 110 such that a pulling force is applied to the transaction card 110 when the transaction card 110 is brought into proximal engagement with or close proximity to the card reading component 122. In some embodiments, the POS device 114 includes a sensor that is configured to sense a polarity of an electromagnetic field generated by a transaction card 110 when the transaction card 110 brought into proximal engagement with the card reading component 122. In some embodiments, once the polarity of the magnetic field is sensed, the POS device 114 generates an electromagnetic field with an opposing polarity such that a pulling force is applied to the transaction card 110.

At step 220, the user 104 engages the transaction card 110 with card reading component 122 of the POS device 114 to complete transaction.

At step 230, in at least some embodiments, the POS device 114 may indicate a completion of the transaction and the transaction card 110 being ready to be removed therefrom. In some embodiments, the completion indication may be a blinking light signal and/or a beeping sound. In some embodiments, the POS device 114 may additionally switch its magnetic component 126 to repel the transaction card 110 and/or activate a linear actuator to push out the transaction card 110 to be retrieved by the user.

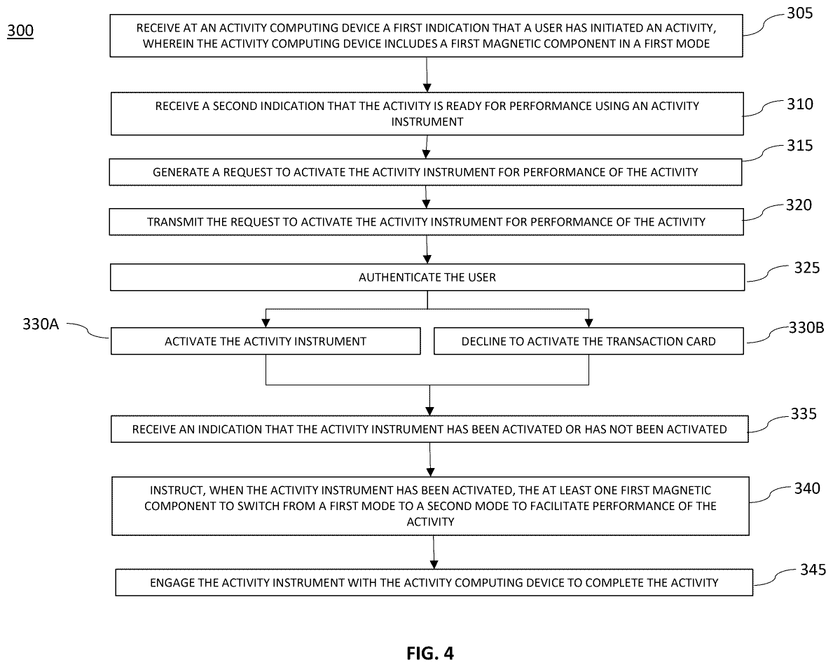

FIG. 4 is a process 300 for alerting a user that a transaction card is activated for use with a POS device or other computing device, according to one or more embodiments of the present disclosure. The exemplary computer-mediated process 300 may be executed by software, hardware or a combination thereof. For example, process 300 may be performed by including one or more components described in the system 100 of FIG. 1 (e.g., user computing device 102, server 106, transaction card 110 and POS device 114). In some embodiments, some or all of the steps described below may be combined and/or divided into sub-steps as appropriate. It will be readily appreciated that other steps may be included in this method, and that not all steps are necessary in all situations.

At step 305, the user 104 initiates a transaction with the POS device 114 or other computing device. In some embodiments, initiating the transaction may include a merchant at the POS device 114 scanning merchandise the user 104 wishes to purchase. In some embodiments, initiating the transaction may include the merchant entering a service to be purchased by the user 104.

In some embodiments, during initiation of the transaction, the POS device 114 may be in a default sleep mode in which the at least one magnetic component 126 is disabled. In some embodiments, the POS device 114 may be in a default mode in which the at least one magnetic component 126 generates a magnetic field that has the same polarity as a known polarity of the transaction card 110 to be used such that if the user 104 brings the transaction card 110 into close proximity of or proximal engagement with the POS device 114, the user 104 feels a repulsive force on the transaction card 110. In some embodiments, the POS device 114 may be in a default mode in which the POS device 114 is able to sense the polarity of the magnetic field generated by the at least one magnetic component 124 of the transaction card 110, when the transaction card 110 is brought into close proximity of the POS device 114, and, in response, generate a magnetic field that has the same polarity from that created by the transaction card 110 such that a repulsive force is delivered to the transaction card 110. Because the POS device 114 applies a repulsive force to the transaction card 110, the user 104 may be deterred from inserting the transaction card into the card reading component 122.

In some embodiments, during initiation of the transaction, in addition to a repulsive force, the transaction card 110 may be configured such that the interaction of the electromagnetic field generated by the at least one magnetic component 126 of the POS device 114 interacts with the at least one vibrating component 150 to cause the transaction card 110 to vibrate when the transaction card 110 is brought into close proximity of the POS device 114.

In some embodiments, close proximity is a distance of 0.1 in to 3 in. In some embodiments, close proximity is a distance of 0.5 in to 3 in. In some embodiments, close proximity is a distance of 1 in to 3 in. In some embodiments, close proximity is a distance of 1.5 in to 3 in. In some embodiments, close proximity is a distance of 2 in to 3 in. In some embodiments, close proximity is a distance of 2.5 in to 3 in.

At step 310, the POS device may receive an indication from the merchant that the transaction is ready to be performed using the transaction card 110. In some embodiments, the POS device may request that the user 104 indicate the type of transaction card 110 that will be used (i.e., a transaction card with at least one magnetic component 124).

At step 315, the POS device may generate a request to the server 106 to activate the transaction card 110 for performance of the transaction.

At step 320, the POS device may transmit the request to the server 106 to activate the transaction card 110 for performance of the transaction.

At step 325, optionally, the server 106 may require authentication of the user 104 prior to activation of the transaction card 110. In some embodiments, the user 104 may be authenticated via the financial application 116. For example, in some embodiments, the user 104 may receive an alert on his/her user computing device 102 indicating that authentication is required. In some embodiments, the server 106 may send an alert to the POS device 114 indicating that the user 104 should be notified that user authentication is required prior to activation of the transaction card 110. In some embodiments, user authentication may include, but is not limited to, entry of a password or a pin to the financial application 116, biometric authentication including, for example, a fingerprint scan, a face scan, etc., or any other authentication process.

At step 330A, if the user is authenticated, the server 106 may activate the transaction card via communication with the card control circuitry. In some embodiments, activation of the transaction card may include activating the at least one magnetic component 124 from a default sleep mode to a transaction mode. In some embodiments, in the transaction mode, the at least one magnetic component 124 may be turned on by supplying an electric current thereto such that the at least one magnetic component 124 generates an electromagnetic field.

At step 330B, if the user is not authenticated, the server 106 may decline activation of the transaction card 110 via communication with the card control circuitry. In some embodiments, the server 106 may also send an alert to the POS device 114 that the user 104 was not authenticated and that the transaction should not be performed.

At step 335, the POS device 114 receives an indication from the server 106 that the transaction card 110 has been activated or has not been activate.

At step 340, the POS device 114 activates that at least one magnetic component 126 from the default mode to a transaction mode that indicates to the user 104 that the card reading component 122 is ready to receive the transaction card 110. In some embodiments, the at least one magnetic component 126 may be turned on by supplying an electric current thereto such that the at least one me magnetic component 126 generates an electromagnetic field. In some embodiments, the electromagnetic field has an opposing polarity of a known electromagnetic field of the transaction card 110 such that a pulling force is applied to the transaction card 110 when the transaction card 110 is brought into proximal engagement with or close proximity to the card reading component 122. In some embodiments, the POS device 114 is able to sense a polarity of an electromagnetic field generated by a transaction card 110 when the transaction card 110 brought into proximal engagement with the card reading component 122 and generate an electromagnetic field with an opposing polarity such that a pulling force is applied to the transaction card 110.

At step 345, the user 104 engages the transaction card 110 with card reading component 122 of the POS device 114 to complete transaction.

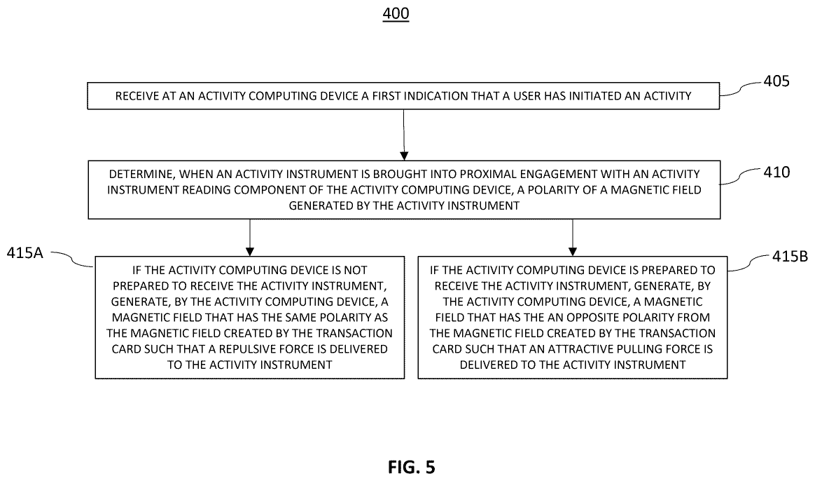

FIG. 5 is a process 400 for alerting a user that a transaction card is activated for use with a POS device or other computing device, according to one or more embodiments of the present disclosure. The exemplary computer-mediated process 300 may be executed by software, hardware or a combination thereof. For example, process 300 may be performed by including one or more components described in the system 100 of FIG. 1 (e.g., user computing device 102, server 106, transaction card 110 and POS device 114). In some embodiments, some or all of the steps described below may be combined and/or divided into sub-steps as appropriate. It will be readily appreciated that other steps may be included in this method, and that not all steps are necessary in all situations.

At step 405, the user 104 initiates a transaction with the POS device 114 or other computing device. In some embodiments, initiating the transaction may include a merchant at the POS device 114 scanning merchandise the user 104 wishes to purchase. In some embodiments, initiating the transaction may include the merchant entering a service to be purchased by the user 104.

At step 410, the POS device 114 may sense the polarity of the magnetic field generated by the at least one magnetic component 124 of the transaction card 110 when the transaction card 110 is brought into close proximity of the POS device 114.

At step 415A, if the POS device 114 is not prepared to receive the transaction card 110, the POS device 114 may, in response to the sensed polarity, generate a magnetic field that has the same polarity as the magnetic field created by the transaction card 110 such that a repulsive force is delivered to the transaction card 110. Because the POS device 114 applies a repulsive force to the transaction card 110, the user 104 may be deterred from inserting the transaction card into the card reading component 122.

In some embodiments, during initiation of the transaction, in addition to a repulsive force, the transaction card 110 may be configured such that the interaction of the electromagnetic field generated by the at least one magnetic component 126 of the POS device 114 interacts with the at least one vibrating component 150 to cause the transaction card 110 to vibrate when the transaction card 110 is brought into close proximity of the POS device 114.

In some embodiments, close proximity is a distance of 0.1 in to 3 in. In some embodiments, close proximity is a distance of 0.5 in to 3 in. In some embodiments, close proximity is a distance of 1 in to 3 in. In some embodiments, close proximity is a distance of 1.5 in to 3 in. In some embodiments, close proximity is a distance of 2 in to 3 in. In some embodiments, close proximity is a distance of 2.5 in to 3 in.

At step 415B, if the POS device 114 is prepared to receive the transaction card 110 so as to facilitate the performance of the activity, the POS device 114 may, in response to the sensed polarity, generate a magnetic field that has an opposite polarity from that created by the transaction card 110 such that an attractive pulling force is delivered to the transaction card 110. Because the POS device 114 applies an attractive pulling force to the transaction card 110, the user 104 may be encouraged to insert the transaction card into the card reading component 122.

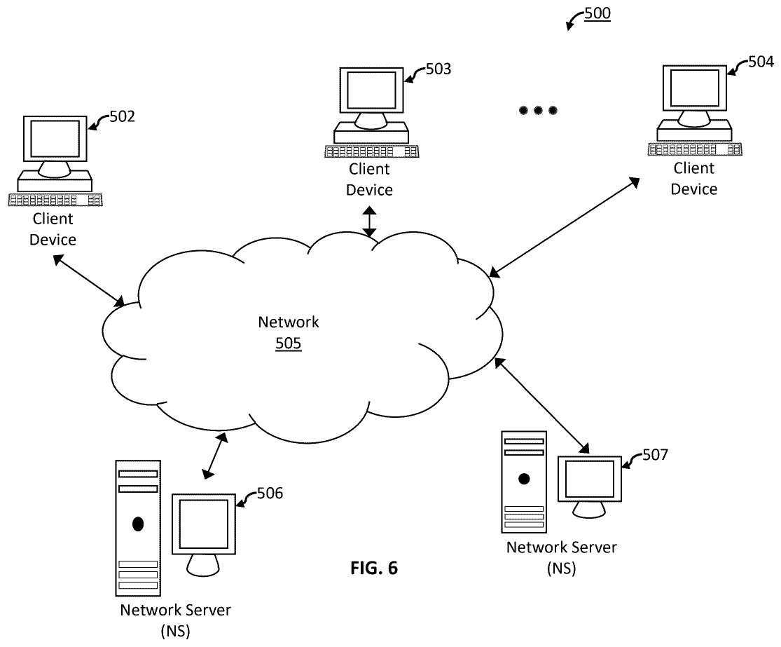

FIG. 6 depicts a block diagram of an exemplary computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 500 may be configured to manage a large number of members and concurrent transactions, as detailed herein. In some embodiments, the exemplary computer-based system and platform 500 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 6, member computing device 502, member computing device 503 through member computing device 504 (e.g., clients) of the exemplary computer-based system and platform 500 may include virtually any computing device capable of receiving and sending a message over a network (e.g., cloud network), such as network 505, to and from another computing device, such as servers 506 and 507, each other, and the like. In some embodiments, the member devices 502-504 may be personal computers, multiprocessor systems, microprocessor-based or programmable consumer electronics, network PCs, and the like. In some embodiments, one or more member devices within member devices 502-504 may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, one or more member devices within member devices 502-504 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more member devices within member devices 502-504 may include may run one or more applications, such as Internet browsers, mobile applications, voice calls, video games, videoconferencing, and email, among others. In some embodiments, one or more member devices within member devices 502-804 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 502-504 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a member device may periodically report status or send alerts over text or email. In some embodiments, a member device may contain a data recorder which is remotely downloadable by the user using network protocols such as FTP, SSH, or other file transfer mechanisms. In some embodiments, a member device may provide several levels of user interface, for example, advance user, standard user. In some embodiments, one or more member devices within member devices 502-504 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 505 may provide network access, data transport and/or other services to any computing device coupled to it. In some embodiments, the exemplary network 505 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 505 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 505 may include and implement, as an alternative or in conjunction with one or more of the above, a WiMAX architecture defined by the WiMAX forum. In some embodiments and, optionally, in combination of any embodiment described above or below, the exemplary network 505 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 505 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 505 may also include mass storage, such as network attached storage (NAS), a storage area network (SAN), a content delivery network (CDN) or other forms of computer or machine readable media.

In some embodiments, the exemplary server 506 or the exemplary server 507 may be a web server (or a series of servers) running a network operating system, examples of which may include but are not limited to Apache on Linux or Microsoft IIS (Internet Information Services). In some embodiments, the exemplary server 506 or the exemplary server 507 may be used for and/or provide cloud and/or network computing. Although not shown in FIG. 6, in some embodiments, the exemplary server 506 or the exemplary server 507 may have connections to external systems like email, SMS messaging, text messaging, ad content providers, etc. Any of the features of the exemplary server 506 may be also implemented in the exemplary server 507 and vice versa.

In some embodiments, one or more of the exemplary servers 506 and 507 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the member computing devices 501-504.

In some embodiments and, optionally, in combination of any embodiment described above or below, for example, one or more exemplary computing member devices 502-504, the exemplary server 506, and/or the exemplary server 507 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

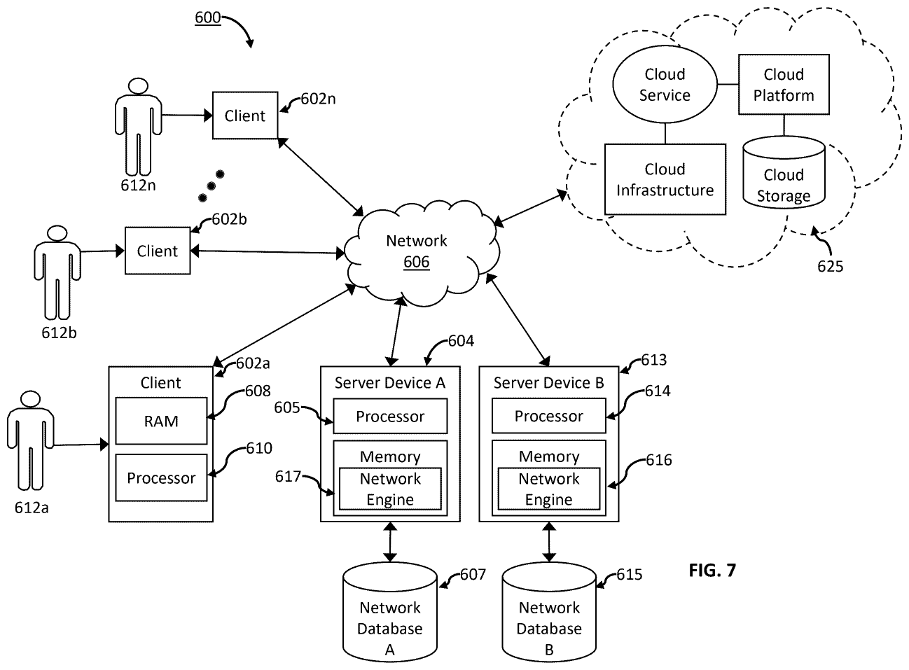

FIG. 7 depicts a block diagram of another exemplary computer-based system and platform 600 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 602a, member computing device 602b through member computing device 602n shown each at least includes a computer-readable medium, such as a random-access memory (RAM) 608 coupled to a processor 610 or FLASH memory. In some embodiments, the processor 610 may execute computer-executable program instructions stored in memory 608. In some embodiments, the processor 610 may include a microprocessor, an ASIC, and/or a state machine. In some embodiments, the processor 610 may include, or may be in communication with, media, for example computer-readable media, which stores instructions that, when executed by the processor 610, may cause the processor 610 to perform one or more steps described herein. In some embodiments, examples of computer-readable media may include, but are not limited to, an electronic, optical, magnetic, or other storage or transmission device capable of providing a processor, such as the processor 610 of client 602a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may include code from any computer-programming language, including, for example, C, C++, Visual Basic, Java, Python, Perl, JavaScript, and etc.

In some embodiments, member computing devices 602a through 602n may also include a number of external or internal devices such as a mouse, a CD-ROM, DVD, a physical or virtual keyboard, a display, or other input or output devices. In some embodiments, examples of member computing devices 602a through 602n (e.g., clients) may be any type of processor-based platforms that are connected to a network 606 such as, without limitation, personal computers, digital assistants, personal digital assistants, smart phones, pagers, digital tablets, laptop computers, Internet appliances, and other processor-based devices. In some embodiments, member computing devices 602a through 602n may be specifically programmed with one or more application programs in accordance with one or more principles/methodologies detailed herein. In some embodiments, member computing devices 602a through 602n may operate on any operating system capable of supporting a browser or browser-enabled application, such as Microsoft™, Windows™ and/or Linux. In some embodiments, member computing devices 602a through 602n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 602a through 602n, user 612a, user 612b through user 612n, may communicate over the exemplary network 606 with each other and/or with other systems and/or devices coupled to the network 606. As shown in FIG. 7, exemplary server devices 604 and 613 may include processor 605 and processor 614, respectively, as well as memory 617 and memory 616, respectively. In some embodiments, the server devices 604 and 613 may be also coupled to the network 606. In some embodiments, one or more member computing devices 602a through 602n may be mobile clients.

In some embodiments, at least one database of exemplary databases 607 and 615 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

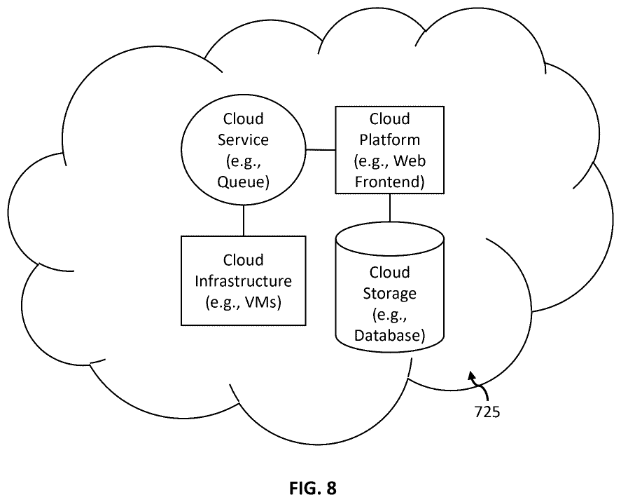

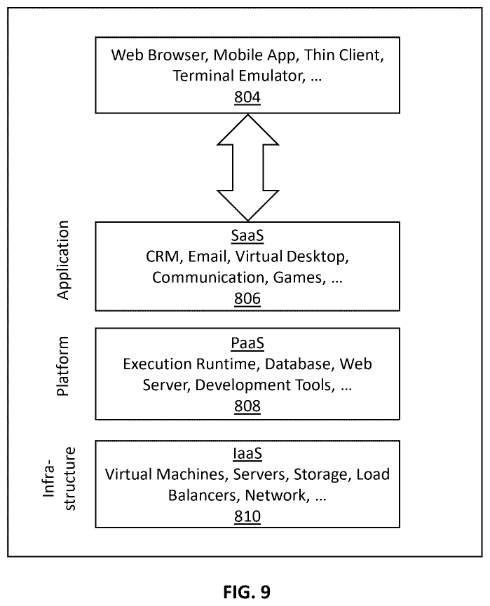

In some embodiments, the exemplary inventive computer-based systems/platforms, the exemplary inventive computer-based devices, and/or the exemplary inventive computer-based components of the present disclosure may be specifically configured to operate in a cloud computing/architecture 625 or 725 such as, but not limiting to: infrastructure a service (IaaS) 810, platform as a service (PaaS) 808, and/or software as a service (SaaS) 806 using a web browser, mobile app, thin client, terminal emulator or other endpoint 804. FIGS. 8 and 9 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.
Clause 1. A method comprising: receiving, by at least one processor of an activity computing device, a first indication that a user has initiated an activity; where the activity computing device is configured to receive an activity instrument to perform the activity; where the activity computing device includes at least one first magnetic component in a first mode; where, in the first mode, the at least one first magnetic component generates a first magnetic field having a first polarity that is configured to interact with a second magnetic field generated by at least one second magnetic component of the activity instrument; where the second magnetic field has a second polarity that is the same as the first polarity so that the activity computing device generates a repulsive force when the activity instrument is in proximal engagement with the activity computing device indicating to the user that the activity computing device is not prepared to receive the activity instrument; receiving, by the at least one processor of the activity computing device, a second indication that the activity is ready for performance using the activity instrument; generating, by the at least one processor of the activity computing device, a request to activate the activity instrument for performance of the activity; transmitting, by the at least one processor of the activity computing device, to a server of an entity associated with the activity instrument, the request to activate the activity instrument for performance of the activity; receiving, by the at least one processor of the activity computing device, a third indication that the activity instrument: has been activated or has not been activated; instructing, by the at least one processor of the activity computing device, when the activity instrument has been activated, the at least one first magnetic component to switch from the first mode to a second mode; where, in the second mode, the at least one first magnetic component generates a third magnetic field having a third polarity that is configured to interact with the second magnetic field generated by the at least one second magnetic component of the activity instrument; where the third polarity is opposite to the second polarity so that the activity computing device generates a pulling magnetic force when the activity instrument is in proximal engagement with the activity computing device, indicating to the user that the activity computing device is prepared to receive the activity instrument so as to facilitate the performance of the activity.
Clause 2. The method of clause 1 or a combination of this clause with at least one clause cited above or below, further comprising: receiving, by the at least one processor of the activity computing device, an alert that authentication of the user is required prior to activation of the activity instrument.
Clause 3. The method of clause 2 or a combination of this clause with at least one clause cited above or below, further comprising: receiving, by the at least one processor of the activity computing device: an alert that the user was authenticated; or an alert that the user was not authenticated; where the activity instrument is activated if the user is authenticated; and where the activity instrument is not activated if the user is not authenticated.
Clause 4. The method of clause 1 or a combination of this clause with at least one clause cited above or below, where the activity computing device provides an indication when the activity is completed, and the activity instrument is ready to be removed.
Clause 5. The method of clause 2 or a combination of this clause with at least one clause cited above or below, where authentication of the user includes: entering at least one of a password or a pin into a financial application on the user computing device, where the financial application is associated with the entity.
Clause 6. The method of clause 1, where the activity instrument further includes at least one vibration component configured to vibrate the activity instrument when the activity instrument is in proximal engagement with the activity computing device, indicating to the user that the activity computing device is not prepared to receive the activity instrument.
Clause 7. The method of clause 1 or a combination of this clause with at least one clause cited above or below, where the activity computing device includes a sensor configured to detect a polarity of the second magnetic field.
Clause 8. The method of clause 7, where the second polarity of the second magnetic field of the activity instrument is a known polarity.
Clause 9. The method of clause 1 or a combination of this clause with at least one clause cited above or below, where the at least one first magnetic component includes an electromagnet, where the electromagnet is configured to change from the first polarity to the third polarity via a direction of an electric current passing therethrough.
Clause 10. A method comprising: receiving, by at least one processor of an activity computing device, a first indication that a user has initiated an activity; where the activity computing device is configured to receive an activity instrument to perform the activity; where the activity computing device includes: at least one first magnetic component configured to generate a first magnetic field; a sensor configured to determine a first polarity of a second magnetic field generated by at least one second magnetic component of the activity instrument; and an activity instrument reading component; determining, by the at least one processor of the activity computing device, when the activity instrument is brought into proximal engagement with the activity instrument reading component, a first polarity of the second magnetic field generated by the at least one second magnetic component of the activity instrument; performing, by the at least one processor of the activity computing device, one of: instructing, by the at least one processor of the activity computing device, the at least one first magnetic component to generate the first magnetic field having a second polarity that is the same as the first polarity of the second magnetic field if the activity instrument reading component is not prepared to receive the activity instrument; where the second polarity of the first magnetic field interacts with the first polarity of the second magnetic field to generate a repulsive force between the activity computing device and the activity instrument; instructing, by the at least one processor of the activity computing device, the at least one first magnetic component to generate the first magnetic field having a third polarity that is opposite the first polarity of the second magnetic field if the activity instrument reading component is prepared to receive the activity instrument; where the third polarity of the first magnetic field interacts with the first polarity of the second magnetic field to generate a pulling force between the activity computing device and the activity instrument so as to facilitate the performance of the activity.
Clause 11. The method of clause 10 or a combination of this clause with at least one clause cited above or below, where the activity instrument further includes at least one vibration component configured to vibrate the activity instrument when the activity instrument is in proximal engagement with the activity computing device, indicating to the user that the activity computing device is not prepared to receive the activity instrument.
Clause 12. The method of clause 10 or a combination of this clause with at least one clause cited above or below, where the at least one first magnetic component includes an electromagnet, where the electromagnet is configured to change from the second polarity to the third polarity via a direction of an electric current passing therethrough.
Clause 13. A system comprising: an activity computing device; a provider server configured to execute software instructions that cause the activity computing device to at least: receive an indication that a user has initiated an activity; where the activity computing device is configured to receive an activity instrument to complete the activity; where the activity computing device includes a first at least one magnetic component in a default mode; where the first at least one magnetic component includes at least one electromagnet; where, in the default mode, the first at least one electromagnet generates a first magnetic field having a first polarity that is configured to interact with a second magnetic field generated by a second at least one magnetic component of the activity instrument; where the second magnetic field has a second polarity that is the same as the first polarity so that the activity computing device generates a repulsive force on the activity instrument when the activity instrument is in proximal engagement with the activity computing device, indicating to the user that the activity computing device is not prepared to receive the activity instrument; receive an indication that the activity is ready for performance using the activity instrument; generate a request to activate the activity instrument for performance of the activity; transmit to a server of an entity associated with the activity instrument, the request to activate the activity instrument for performance of the activity; receive an indication that the activity instrument is one of: activated; or not activated; instruct, when the activity instrument is activated, the first at least one magnetic component to switch from the default mode to an activity performance mode; where, in the activity performance mode, the first at least one electromagnetic generates a third magnetic field having a third polarity that is configured to interact with the second magnetic field generated by the second at least one magnetic component of the activity instrument; where the third polarity is opposite the second polarity so that the activity computing device generates a pulling force on the activity instrument when the activity instrument is in proximal engagement with the activity computing device, indicating to the user that the computing device is prepared to receive the activity instrument; receive the activity instrument to perform the activity.
Clause 14. The system of clause 13 or a combination of this clause with at least one clause cited above or below, where the provider server is further configured to execute software instructions that cause the activity computing device to: receive an alert that authentication of the user is required prior to activation of the activity instrument.
Clause 15. The system of clause 14 or a combination of this clause with at least one clause cited above or below, where the provider server is further configured to execute software instructions that cause the activity computing device to: receive: an alert that the user was authenticated; or an alert that the user was not authenticated; where the activity instrument is activated if the user is authenticated; and where the activity instrument is not activated if the user is not authenticated.
Clause 16. The system of clause 14 or a combination of this clause with at least one clause cited above or below, where the activity instrument is associated with a financial application on a user computing device of the user.
Clause 17. The system of clause 16 or a combination of this clause with at least one clause cited above or below, where authentication of the user includes: entering at least one of a password or a pin into the financial application on the user computing device, where the financial application is associated with the entity.
Clause 18. The system of clause 13 or a combination of this clause with at least one clause cited above or below, where the activity instrument further includes at least one vibration component configured to vibrate the activity instrument when the activity instrument is in proximal engagement with the activity computing device, indicating to the user that the activity computing device is not prepared to receive the activity instrument.
Clause 19. The system of clause 13 or a combination of this clause with at least one clause cited above or below, where the activity computing device includes a sensor configured to detect a polarity of the second magnetic field.
Clause 20. The system of clause 13 or a combination of this clause with at least one clause cited above or below, where the second polarity of the second magnetic field of the activity instrument is a known polarity.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A method comprising:
receiving, by at least one processor of an activity computing device, a first indication that a user has initiated an activity;
wherein the activity computing device is configured to receive an activity instrument to perform the activity;
wherein the activity computing device comprises at least one first magnetic component switching between a first and a second mode; and
instructing, by the at least one processor of the activity computing device, the at least one first magnetic component to generate:
when in the first mode: a first magnetic field having a first polarity that is configured to interact with a second magnetic field generated by at least one second magnetic component of the activity instrument;
wherein the second magnetic field has a second polarity that is the same as the first polarity so that the activity computing device generates a repulsive force when the activity instrument is in proximal engagement with the activity computing device indicating to the user that the activity computing device is not prepared to receive the activity instrument; and
when in the second mode:
a third magnetic field having a third polarity that is configured to interact with the second magnetic field generated by the at least one second magnetic component of the activity instrument;
wherein the third polarity is opposite to the second polarity so that the activity computing device generates a pulling magnetic force when the activity instrument is in proximal engagement with the activity computing device, indicating to the user that the activity computing device is prepared to receive the activity instrument so as to facilitate a performance of the activity.

2. The method of claim 1, further comprising:
receiving, by the at least one processor of the activity computing device, a second indication that the activity is ready to be performed using the activity instrument;
transmitting, by the at least one processor of the activity computing device, a request to activate the activity instrument for performing the activity to a server of an entity associated with the activity instrument; and
receiving, by the at least one processor of the activity computing device, a third indication of an activation status of the activity instrument before instructing the at least one first magnetic component.

3. The method of claim 2, further comprising receiving, by the at least one processor of the activity computing device, an alert that authentication of the user is required prior to an activation of the activity instrument.

4. The method of claim 3, wherein the authentication of the user comprises:
entering at least one of a password or a pin into a financial application on the user computing device;
wherein the financial application is associated with the entity.

5. The method of claim 3, further comprising:
receiving, by the at least one processor of the activity computing device:
an alert that the user was authenticated; or
an alert that the user was not authenticated;
wherein the activity instrument is activated if the user is authenticated; and
wherein the activity instrument is not activated if the user is not authenticated.

6. The method of claim 1, wherein the activity computing device is configured to provide an indication when the activity is completed, and the activity instrument is ready to be removed.

7. The method of claim 1, wherein the activity instrument further comprises at least one vibration component configured to vibrate the activity instrument when the activity instrument is in proximal engagement with the activity computing device, indicating to the user that the activity computing device is not prepared to receive the activity instrument.

8. The method of claim 1, wherein the activity computing device comprises a sensor configured to detect a polarity of the second magnetic field.

9. The method of claim 1, wherein the second polarity of the second magnetic field of the activity instrument is a known polarity.

10. The method of claim 1, wherein the at least one first magnetic component comprises an electromagnet;
wherein the electromagnet is configured to change from the first polarity to the third polarity via a direction of an electric current passing therethrough.

11. A system comprising:
an activity computing device configured to execute software instructions that cause the activity computing device to:
receive an indication that a user has initiated an activity;
wherein the activity computing device is configured to receive an activity instrument to complete the activity;
wherein the activity computing device comprises at least one first magnetic component switching between a first and a second mode; and
instruct the at least one first magnetic component to generate:
when in the first mode: a first magnetic field having a first polarity that is configured to interact with a second magnetic field generated by at least one second magnetic component of the activity instrument;
wherein the second magnetic field has a second polarity that is the same as the first polarity so that the activity computing device generates a repulsive force on the activity instrument when the activity instrument is in proximal engagement with the activity computing device, indicating to the user that the activity computing device is not prepared to receive the activity instrument; and
when in the second mode: a third magnetic field having a third polarity that is configured to interact with the second magnetic field generated by the at least one second magnetic component of the activity instrument;
wherein the third polarity is opposite the second polarity so that the activity computing device generates a pulling force on the activity instrument when the activity instrument is in proximal engagement with the activity computing device, indicating to the user that the computing device is prepared to receive the activity instrument so as to facilitate a performance of the activity.

12. The system of claim 11, wherein the instructions further cause the activity computing device to:
receive a second indication that the activity is ready to be performed using the activity instrument;
transmit a request to activate the activity instrument for performing the activity to a server of an entity associated with the activity instrument; and
receive a third indication of an activation status of the activity instrument before instructing the at least one first magnetic component.

13. The system of claim 12, wherein the instructions further cause the activity computing device to receive an alert that authentication of the user is required prior to activation of the activity instrument.

14. The system of claim 13, wherein instructions further cause the activity computing device to receive:
an alert that the user was authenticated; or
an alert that the user was not authenticated;
wherein the activity instrument is activated if the user is authenticated; and
wherein the activity instrument is not activated if the user is not authenticated.

15. The system of claim 14, wherein the activity instrument is associated with a financial application on a computing device of the user.

16. The system of claim 15, wherein the authentication of the user comprises:
entering at least one of a password or a pin into the financial application on the user computing device;
wherein the financial application is associated with the entity.

17. The system of claim 11, wherein the activity instrument further comprises at least one vibration component configured to vibrate the activity instrument when the activity instrument is in proximal engagement with the activity computing device, indicating to the user that the activity computing device is not prepared to receive the activity instrument.

18. The system of claim 11, wherein the activity computing device comprises a sensor configured to detect a polarity of the second magnetic field.

19. The system of claim 11, wherein the second polarity of the second magnetic field of the activity instrument is a known polarity.

20. The system of claim 11, wherein the at least one first magnetic component comprises an electromagnet;
wherein the electromagnet is configured to change from the first polarity to the third polarity via a direction of an electric current passing therethrough.
